(19) United States
(12) Patent Application Publication
(10) Pub. No.: US 2017/0308811 A1
(43) Pub. Date: Oct. 26, 2017

(54) Talent Artificial Intelligence Virtual Agent Bot

(71) Applicant: Vishal Kumar, Nashua, NH (US)

(72) Inventor: Vishal Kumar, Nashua, NH (US)

(73) Assignee: Vishal Kumar, Nashua, NH (US)

(21) Appl. No.: 15/493,108

(22) Filed: Apr. 20, 2017

Related U.S. Application Data
(60) Provisional application No. 62/325,460, filed on Apr. 21, 2016.

(51) Int. Cl. G06N 99/00

(52) U.S. Cl. CPC G06N 99/005

(57) ABSTRACT

Talent Artificial Intelligence Virtual Agent (“TAIVA”) performs the function of an artificial intelligence driven career coach agent. The invention may serve the human resource, talent analytics, employee engagement and independent career coach functions for enterprises and professionals. Similar to a career coach who works with talent and helps them discover better opportunities and growth, this invention uses the power of machine learning and collaborative findings to discover the opportunities. The system's capabilities range from providing suggestions on career changes, helping grow in cluster of skillsets, crowd collaborate to task level gigs, build capabilities etc. The system starts with small interactions and as it learns about the candidate and other members in the network, it will use the power of Artificial intelligence, collaborative findings and global trends to create adaptive and relevant suggestive map and progress dashboard for the candidates just like a career coach.

### SUMMARY OF THE INVENTION AND ADVANTAGES

The subject invention comprises a method and apparatus for learning about talent using professional's knowledge, skill depth, environmental influencers, expertise and experience in skillset. The system starts with self-declared and/or learned candidate skillset form. Initial skillsets and other influencing parameters will be used to create initial profile of the candidate and based on professional's interaction with the system, the clustered and the machine learning algorithms (the invention) would gain substantial insight about the candidate. Invention also uses other interactions within the TAIVA system to extrapolate the findings about any particular subject/professional in question. TAIVA keeps skillsets & other influential variables at the center of the system and learns about a candidate, their teams, their company and maps all the tasks, learning incurred around skillset and creates an extensive profile which helps with connecting identical candidates, provide mentor network, find relevant jobs, find relevant content/trainings, create teams etc. The Artificial Intelligence system will be able to predict the success of team, success of mentors, next hires etc. which are some crucial findings for any business. TAIVA system also has capability to work across candidate's cluster of skillsets and provide targeted suggestions, work opportunities around those clusters. This enables TAIVA to provide crowd tasks to candidates so the experts could be connected to problems on task basis. System will get smarter with every transaction between a professional and TAIVA system.

### BRIEF DESCRIPTION OF THE DRAWINGS

Invention could be further explained and clarified using a stack of algorithmic, and architectural flowchart designs. The drawings shed more light into the invention, wherein:

FIG. 001: Describes how various modules act together.

FIG. 002: Describes how a every component gets converted to a profile for monitoring

FIG. 003: Describes how a profile is stored as a collection of skillsets, which is also influenced by public as well as environment variables

FIG. 004: Describes how two profiles could be compared to extract coach like capabilities via this system

### DETAILED DESCRIPTION OF THE PREFERRED EMBODIMENT

### Related Art:

Current professionals find it difficult to get any help on ways to help grow in their profession. Sports athletes have career coaches and managers that work with them to make sure that they get best opportunities, are re-presented to best of current abilities and have plans to help grow in their career. Not many professionals are privileged to have the same kind of support system. So, a professional/candidate needs to learn these tangential skills (such as act like a human resource while looking for job, act like a coach while picking a course for career growth and act like a PR expert while building his professional brand etc.). Professionals are not an expert in all of the above areas, and they could end up making colossal career mistakes while learning the hard way. Current system is broken, convoluted and risks the candidate through painstakingly difficult decision-making process.

A similar problem exists in enterprises where each candidate is measured and evaluated in non-real-time, obsolete and indirect/passive manner. During a candidate's evaluation, a lot of wild and inaccurate assumptions could be made. For eg. It is assumed that past activities will influence the future, leaving no room for improvements. This has also resulted in inaccurate ways to evaluate the candidate and unnecessary churn and lower engagement.

To learn new skills, candidates could complete a ton of training through the current systems. Most of the systems that exist today work in pull-manner where a candidate needs to pull information out of the system to learn and upgrade their skillsets. These pull-systems makes the candidate susceptible to errors as they rely on their instinct on pulling the right information/training and the information is not custom carved to candidate's interests. This has led to inefficiencies in the system that is expensive and time consuming.

A similar problem exists where teams are created to accomplish a project. The methodologies used to build the team are based on passive indicators and on self- acclaimed/perceived notions and not on the individual's skill sets and experience. This might result in inaccurate team formations, which ultimately results in, failed teams and thereby failed projects.

A similar problem exists where professionals could not sell their freelance hours to make crowdsourcing a possibility. Users must drive the effort, signup, push ads and filter through requests for a small to moderate participation. This is not a best way to make task based crowdsourcing possible. And, these systems are not capturing the improvement in the skills achieved by projects that can help in future placements.

### Current Invention Description

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The invention uses the element of data sourcing of any information that measures, trains and empowers the worker's knowledge to help create an artificial intelligence lead, community learned platform. The invention ingests all the information and algorithms process this data and mix it with past data, outside data, real-time transactional data and survey data to create insight that helps the system in creating relationship of relevance and appropriation to understand best-suited knowledge for best entity. The system ingests content (which could be a course, tutorial, article, video, audio, image media content), tasks (fulltime, part-time, hourly tasks), job (fulltime, part-time, volunteer, contract jobs) and candidate profiles. The system then using embodied and/or acquired algorithms generates a relationship of relevance for better understanding the relationship between content to content, content to job, content to task, content to candidate and generate similar relationships within content, task, job and candidate.

System also embodies the element of storage to share transactional interactions/data to build a time-series information log to help generate a more informed system that is time-continuum aware. Due to the ability of the system to capture profile details and perform comparative reputational analysis, several other use case might also emerge which are not part of this application but use the same underline technology.

Figures of the invention sheds more light on how the architecture is laid that build the foundation of talent artificial intelligence virtual agent.

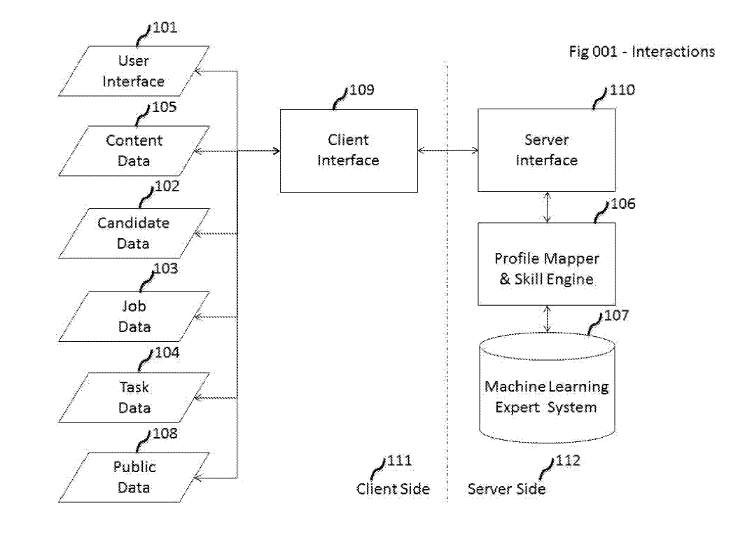

FIG. 001: Displays the working TAIVA system at a high level. It shed the light on the fact that Profile Mapper/Skill Engine is the heart of the system and everything that the system ingests gets converted to profile and there by associated skills are mapped for the system to work. The image suggests that they system could undertake Candidate Profile (FIG. 001.102, Participating worker candidate profile for part-time, full-time, consulting profile etc.), Job Profile (FIG. 001.103, this module could take full-time, part-time, contracting job profiles), Task Profile (FIG. 001.104, this module could take various tasks that are hourly etc.) and Content Profile (FIG. 001.105, this module could take content like courses, online videos, tutorials, articles, books, and any content/media that is consumed by system users). All the profile modules interact with “Profile Mapper and Skill Engine” (FIG. 001.106). This engine then uses power of Machine Learning Expert System (FIG. 001.107) to use the information and mix with external content (FIG. 001.108) to provide coach like insights. User interface (FIG. 001.101) is designed and equipped to work with all the above said modules and use the power of skillset engine and machine learning expert system to provide a targeted recommendation and a learning system that grows smarter with every transaction and interaction with the system. The whole system is split into 2 core parts, Client Side (FIG. 001.111) and Server side (FIG. 001.112). Client side has all the data and input/output interfaces, Client Interface (FIG. 001.109). Similarly, server side gets an interface that deal with data transactions between client-server, server-server or system-server using server interface (FIG. 001.1010).

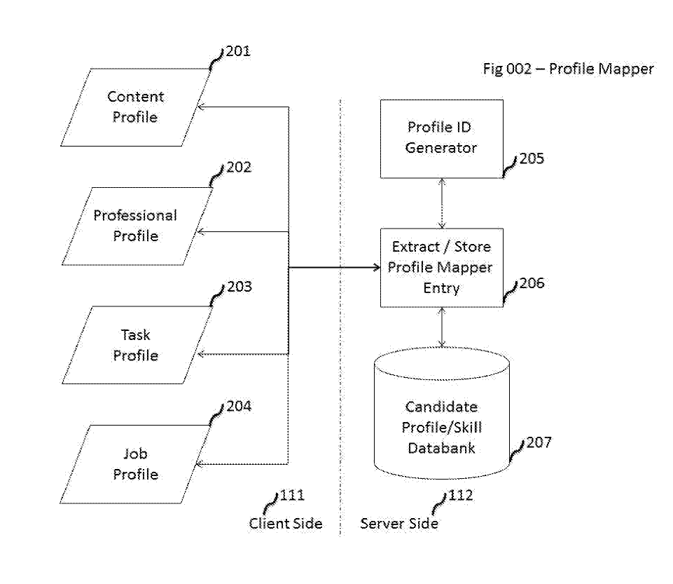

FIG. 002: Explains the process on how a Content Profile (FIG. 002.201), Professional Profile (FIG. 002.202), Task Profile (FIG. 002.203) and Job Profile (FIG. 002.204) work. For TAIVA to work all the intractable entity should be first converted to profile and FIG. 002 sheds light on that. Every intractable entity should first interact with Extract/Store profile mapper entry routine (FIG. 002.206) that first interacts with Profile ID Generator (FIG. 002.205) module to provide ID for the entity. This ID will be used as the basis for all future interactions. All the profile entries and corresponding time-series interactions are stored in Candidate Profile/Skill databank (FIG. 002.207). This process helps understand how any entity that TAIVA uses is tracked using profile ID.

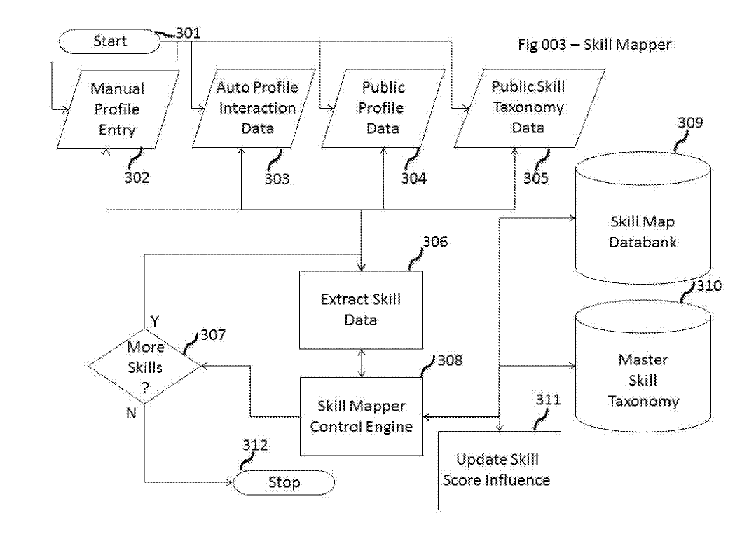

FIG. 003: Sheds light on 3rd important component workflow in the TAIVA system's functionality. For TAIVA to work, every profile ID needs to be further mapped to all the skillsets that help define which profile has what skills associated with it. Skill Mapper functionality of core module breaks each profile to multiple skills. For effective machine learning and career coach functionality, it is important for TAIVA to monitor skillset relevance to a profile with time-series like functionality. Initially Manual profile (FIG. 003.302) is chosen and using manual or automated means the skill information is extracted using “Extract Skill Data” (FIG. 003.306) module. TAIVA is also designed to work with engagement interface/interactive data (FIG. 003.303) and public profile data (FIG. 003.304). All captured data around a skillset is stored in time-series manner to understand the impact of time on a skillset based for a profile. Extracted data is then further mapped to skill using Skill Mapper Control Engine (FIG. 003.308), which processes the information and stores the skill information in Skill Map Databank (FIG. 003.309). If (FIG. 003.307) there are more skills than are associated with a profile, then (FIG. 003.307) system will extract each skill information (using: FIG. 003.306, FIG. 003.308, FIG. 003.309) and process it. Skill mapper control engine extracts skill data and uses it to update skill score influence (FIG. 003.311) that will help in understanding how a skill influences a profile. If there are outside skill taxonomies available, TAIVA can interact with out side public taxonomy data (FIG. 003.305) and every transaction also impacts the master skill taxonomy (FIG. 003.310) that TAIVA maintains to keep the system updated on future skill evaluations and its impact on different profile types.

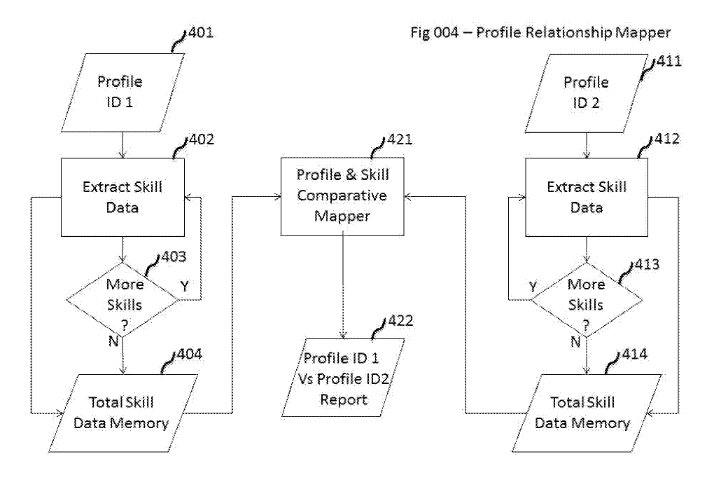

FIG. 004: This figure sheds light on one of the core functionality that makes the career coach capability viable. It is the ability to reason two profile entries and identify their influence on each other. Each profile is considered with its skill parameters and mapped against other skill type to get the influence of one profile on other. This capability is additive in nature, meaning, profiles could be cascaded and then mapped against a type or two sets of profiles could be compared together. For simplification, this figure explains a common set of comparisons between profile 1 and profile 2. As a workflow, Profile ID 1 information and Profile ID 2 information is fetched. For Profile ID1 & Profile ID2, Skill data is extracted (FIG. 004.402, FIG. 004.412). If (FIG. 004.403, FIG. 004.413) more skills are associated with Profile ID1 & Profile ID2, all the skills are extracted till nothing else is left to be extracted. Each extracted skill map is stored in “Total Skill Data Memory” module (FIG. 004.404, FIG. 004.414). Once total skill data memory is extracted for both profiles, they are sent to comparative mapper (FIG. 004.421) to identify relationship between profiles. The mapper then generates a report (FIG. 004.422) that is used to make actionable insights that is used further to help TAIVA work as a career coach.

Typical use cases that emerge from this invention are the byproducts of the inventions ability to attach an artificial intelligence to profiles of content, jobs, tasks and candidates. Algorithms associated with the invention make use of current, past and parallel data for helping. Some of the common use case includes but not limited to:
Ability to map talent progression roadmap from identical candidate profiles,
Ability to connect mentors-mentee based on career roadmap from current candidate profile skills and how they appreciate career progression
Ability to connect content profile to candidate profile to help with career progression, such as course, article, video, media suggestions and measuring impact
Ability to measure return on impact for content based on their impact on candidate profile skills
Ability to connect task profiles with candidate profiles to help with career progression
Ability to connect job profiles with candidate profiles to help connect most suitable jobs for candidates
Ability to connect which content profiles suit which task profiles for improving ramp up
Ability to connect which content profile suits which job profile for improving job success and ramp up
Ability to identify stack of candidate profiles that best suit to perform task profile for measuring most optimal team for performing a task
Ability to connect candidate profile with job profile for building ideal succession plan
Ability to map task profile with candidate profile to measure which candidates prefer which task structure
Ability of measure which task profiles generates maximum probability of being completed in time
Ability to connect job, task, content and candidate profile with each other for all the informed analysis to measure productivity and optimal outcome.

1. A method comprising:
Receiving, on client system, an interface inputs around the activity that needs to be performed by Talent Artificial Intelligence Virtual Agency (Abbreviated as TAIVA system) system,
Receiving, interface input routine functions include but not limited to ability to find relevant relational connections within and/or between content, task, job and candidate
Communicating, by client system to server system, the interface inputs so serve system could understand the tasks that are needed to be performed
Receiving, on server system, a task set on the activities that are needing to be performed on the TAIVA system
Determining, by server system the tasks that are needed to be executed to perform the functions required by the TAIVA system.
Receiving, through a client system and/or server system inputs captured around information pertaining to entities including but not limited to content, job, task and candidate data that is required to perform the tasks as requested by interface client system.
Analyzing, by server system, the tasks that are needed to be performed and analysis/processing is stored for reporting back to client interface
Reporting, by server system, the result analysis, report and functions that are requested to be performed
Converting, by server system, any entity as job, task, content and candidate information as a profile that is further monitored across time-series

2. A system of claim 1 wherein job entity is information related to job profile, job databank, job type, skills required to do the job, experience, expertise required and any other category/classification that defines everything the system wants to know about the job.

3. A system of claim 1 wherein task entity is information related to task profile, task databank, task type, skills required to do the task, experience, expertise required and any other category/classification that defines everything about task.

4. A system of claim 1 wherein candidate entity is information about a candidate profile, demography, social economic data, skill information and competencies and any other information that helps understand accurate candidate profile.

5. A system of claim 1 wherein TAIVA system monitored and stored time-series continuously increasing data collection may or may not help system gain higher accuracy/precision in advent of more data used towards a decision-making analysis

6. A system of claim 1 wherein content entity includes but not limited to: news, articles, book, media files, courses and anything that does not fall under the scope of job, task, and candidate profile.

7. A system of claim 1 wherein profile, that is created, when combined with its own data and data that is available from dependent profiles/skills is further used in the generation of DNA like score (Skill Score Influence) for each skill and profile type

8. A system of claim 7 wherein the DNA generated is used to establish relational analysis between 2 profiles or skills, wherein each profile or skill could also be group of profiles and/or skills stacked together under common classification for comparison purposes

9. A system of claim 1 wherein the architecture designed to pursue the system comprise of:
Client System, that is responsible for gathering inputs and receiving outputs from the server system.
Server System, that is responsible for processing all the required processes needed for the functionality of the TAIVA system
Client System and Server System are arranged as but not limited to standalone single system, individual systems, distributed across multiple centralized or distributed systems, or each single system is distributed across multiple systems

10. The system of claim 9 wherein the system could be used as standalone, or clustered system, shared via public and or private cloud to deliver a public and/or private system for capturing data and providing insights.

11. A system of claim 9 wherein the system can recruit resources from outside as well as inside system for a brief routine to function as client and/or server for optimal processing experience

12. A method of step 9 wherein data captured could be further used by machine learning and supporting algorithms to enable talent analytics career coach and skill/profile relevance capabilities.

13. A client system comprising:
A set of modules responsible for manually entering the interface value that translates to command that are needed to be executed by TAIVA system
A set of modules responsible for capturing manual entries around entities including but not limited to content, task, job and candidate
A set of modules responsible for capturing automated entries internally and/or externally from TAIVA system
A system that validates the viability and semantics of the interface commands as well as input information
A system of application program interface adapters to interact with outside systems for fetching data that would be used by TAIVA system

14. A method of claim 13 wherein client system could capture inputs from resources including but not limited to manual interactions, system interactions, automated routines, outside public/private data and inside recorded profile/skill recorded data.

15. A server system comprising of:
A processing center for catering to client side interface requests
A storage and databank that stores transactional, relational and entity data that may directly or indirectly be used to process system requests
A system of application program interface that may or may not interact with outside systems and services to share processing, data and analysis
A data store that can break entity into profiles and profiles into skills, thereby helping break all entities including but not limited to task, job, content and candidate information into profiles and each profile is associated one or more skillsets with relevant skillset information
An algorithmic set that includes library of mathematical models that could be applied on data store as well as real-time captured data to provide analysis/insight.

16. A system of claim 15 wherein TAIVA system could use direct, indirect, real-time, pre-stored data to identify relational influence using data captured around calculated 2 entities (among task, job, content and candidate) and measure how the two entities or set of entities influence each other and influence neighbors, and also vice a versa.

17. A method of claim 15 wherein the system is capable to sharing logic, analysis, models as well as data from data store with outside system as well as other system modules for effective learning and helping keep system adaptable to market changes
